(19) United States
(12) Patent Application Publication
(10) Pub. No.: US 2026/0101152 A1
(43) Pub. Date: Apr. 9, 2026

(54) Sound Processing Method, Sound Processing Apparatus, and Non-Transitory Computer-Readable Storage Medium Storing Sound Processing Program

(71) Applicant: YAMAHA CORPORATION, Hamamatsu-shi (JP)

(72) Inventors: Hayato YAMAKAWA, Hamamatsu-shi (JP); Yu TAKAHASHI, Hamamatsu-shi (JP)

(21) Appl. No.: 19/405,888

(22) Filed: Dec. 2, 2025

Related U.S. Application Data
(63) Continuation of application No. PCT/JP2024/021652, filed on Jun. 14, 2024.

(30) Foreign Application Priority Data
Jul. 7, 2023 (JP) 2023-112351

(51) Int. Cl. H04S 7/00

(52) U.S. Cl. CPC H04S 7/307; H04S 7/40

(57) ABSTRACT

A sound processing method includes receiving and mixing sound signals fed from a plurality of input channels to produce a mixed sound signal. The sound processing method also includes displaying a spectral diagram for the sound signals on the plurality of input channels or for the mixed sound signal. The sound processing method also includes computing a similarity index with respect to a given frequency band from the sound signals on the plurality of input channels and the mixed sound signal. The sound processing method also includes modifying a display representation for the given frequency band in the spectral diagram on the basis of the similarity index, in association with at least one of the plurality of input channels.

### CROSS-REFERENCE TO RELATED APPLICATIONS

The present application is a continuation application of International Application No. PCT/JP2024/021652, filed June 14, 2024, which claims priority to Japanese Patent Application No. 2023-112351, filed July 7, 2023. The contents of these applications are incorporated herein by reference in their entirety.

### BACKGROUND

The present disclosure relates to a sound processing method, a sound processing apparatus, and a non-transitory computer-readable storage medium storing a sound processing program.

WO 2006/100980 A1 discloses an audio signal processing device involving: acquiring an audio signal with components discriminated according to frequency bands; allocating of respective pieces of different color data to the components with the different frequency bands in the acquired audio signal; modulating the brightness of the respective pieces of color data on the basis of the individual levels of the components with the different frequency bands in the acquired audio signal to produce respective pieces of modulated data; combining the respective pieces of modulated data from the different frequency bands to produce combined data; and using the combined data to create image data to be displayed on an image display device.

A user (or, for example, an operator of an audio mixer) may wish to adjust the frequency characteristic of a plurality of sound signals on respective channels before mixing, so that the frequency characteristic of the mixed signal made from the sound signals on the respective channels better conforms to a target or desired characteristic.

The user may have a hard time finding out which channel or channels should be selected for adjustment.

An object of the present disclosure is to provide a sound processing method, apparatus, and/or program that make(s) it easier to find out which channel or channels should be selected for adjustment.

### SUMMARY

One aspect is a sound processing method that includes receiving and mixing sound signals fed from a plurality of input channels to produce a mixed sound signal. The sound processing method also includes displaying a spectral diagram for the sound signals on the plurality of input channels or for the mixed sound signal. The sound processing method also includes computing a similarity index with respect to a given frequency band from the sound signals on the plurality of input channels and the mixed sound signal. The sound processing method also includes modifying a display representation for the given frequency band in the spectral diagram on the basis of the similarity index, in association with at least one of the plurality of input channels.

Another aspect is a sound processing method that includes receiving and mixing sound signals fed from a plurality of input channels to produce a mixed sound signal. The sound processing method also includes receiving a target frequency characteristic for the mixed sound signal. The sound processing method also includes computing a similarity index with respect to a given frequency band from one of the sound signals, which is fed from one of the plurality of input channels, and the target frequency characteristic. The sound processing method also includes selecting a most dominant channel among the plurality of input channels in the given frequency band in relation to the target frequency characteristic, on the basis of the similarity index.

Another aspect is a sound processing apparatus that includes a processor and a memory. The memory stores instructions that, when executed by the processor, cause the processor to carry out receiving and mixing sound signals fed from a plurality of input channels to produce a mixed sound signal. The instructions, when executed by the processor, also cause the processor to carry out displaying a spectral diagram for the sound signals on the plurality of input channels or for the mixed sound signal. The instructions, when executed by the processor, also cause the processor to carry out computing a similarity index with respect to a given frequency band from the sound signals on the plurality of input channels and the mixed sound signal. The instructions, when executed by the processor, also cause the processor to carry out modifying a display representation for the given frequency band in the spectral diagram on the basis of the similarity index, in association with at least one of the plurality of input channels.

Another aspect is a sound processing apparatus that includes a processor and a memory. The memory stores instructions that, when executed by the processor, cause the processor to carry out receiving and mixing sound signals fed from a plurality of input channels to produce a mixed sound signal. The instructions, when executed by the processor, also cause the processor to carry out receiving a target frequency characteristic for the mixed sound signal. The instructions, when executed by the processor, also cause the processor to carry out computing a similarity index with respect to a given frequency band from one of the sound signals, which is fed from one of the plurality of input channels, and the target frequency characteristic. The instructions, when executed by the processor, also cause the processor to carry out selecting a most dominant channel among the plurality of input channels in the given frequency band in relation to the target frequency characteristic, on the basis of the similarity index.

Another aspect is a non-transitory computer-readable storage medium storing a sound processing program executable by at least one processor of a sound processing apparatus. The sound processing program, when executed by the at least one processor, causes the at least one processor to execute a method that includes receiving and mixing sound signals fed from a plurality of input channels to produce a mixed sound signal. The method also includes displaying a spectral diagram for the sound signals on the plurality of input channels or for the mixed sound signal. The method also includes computing a similarity index with respect to a given frequency band from the sound signals on the plurality of input channels and the mixed sound signal. The method also includes modifying a display representation for the given frequency band in the spectral diagram on the basis of the similarity index, in association with at least one of the plurality of input channels.

Another aspect is a non-transitory computer-readable storage medium storing a sound processing program executable by at least one processor of a sound processing apparatus. The sound processing program, when executed by the at least one processor, causes the at least one processor to execute a method that includes receiving and mixing sound signals fed from a plurality of input channels to produce a mixed sound signal. The method also includes receiving a target frequency characteristic for the mixed sound signal. The method also includes computing a similarity index with respect to a given frequency band from one of the sound signals, which is fed from one of the plurality of input channels, and the target frequency characteristic. The method also includes selecting a most dominant channel among the plurality of input channels in the given frequency band in relation to the target frequency characteristic, on the basis of the similarity index.

A sound processing method, apparatus, and/or program according to the present disclosure make(s) it easier to find out which channel or channels should be selected for adjustment.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a block diagram illustrating the configuration of an audio mixer 1;

FIG. 2 is a block diagram illustrating the functional elements in signal processing;

FIG. 3 is a block diagram illustrating how an input channel module 302, a stereo bus 303, and a MIX bus 304 are functionally configured;

FIG. 4 is a schematic view of a control panel of the audio mixer 1;

FIG. 5 is a flowchart of the operation of a sound processing method implemented by the audio mixer 1;

FIG. 6 shows an example spectral diagram;

FIG. 7 shows the example spectral diagram after undergoing display representation modification;

FIG. 8 shows another representation example of the spectral diagram;

FIG. 9 shows another representation example of the spectral diagram; and

FIG. 10 is a flowchart of the process of selecting the most dominant channel.

### DETAILEDDESCRIPTION

The present specification is applicable to a sound processing method, a sound processing apparatus, and a non-transitory computer-readable storage medium storing a sound processing program.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure. In the accompanying drawings referenced in the embodiments, similar reference numerals, characters, or symbols may be used to indicate corresponding or identical elements. For example, to distinguish like elements, “A” may be appended to a reference numeral and “B” may be appended to the same reference numeral.

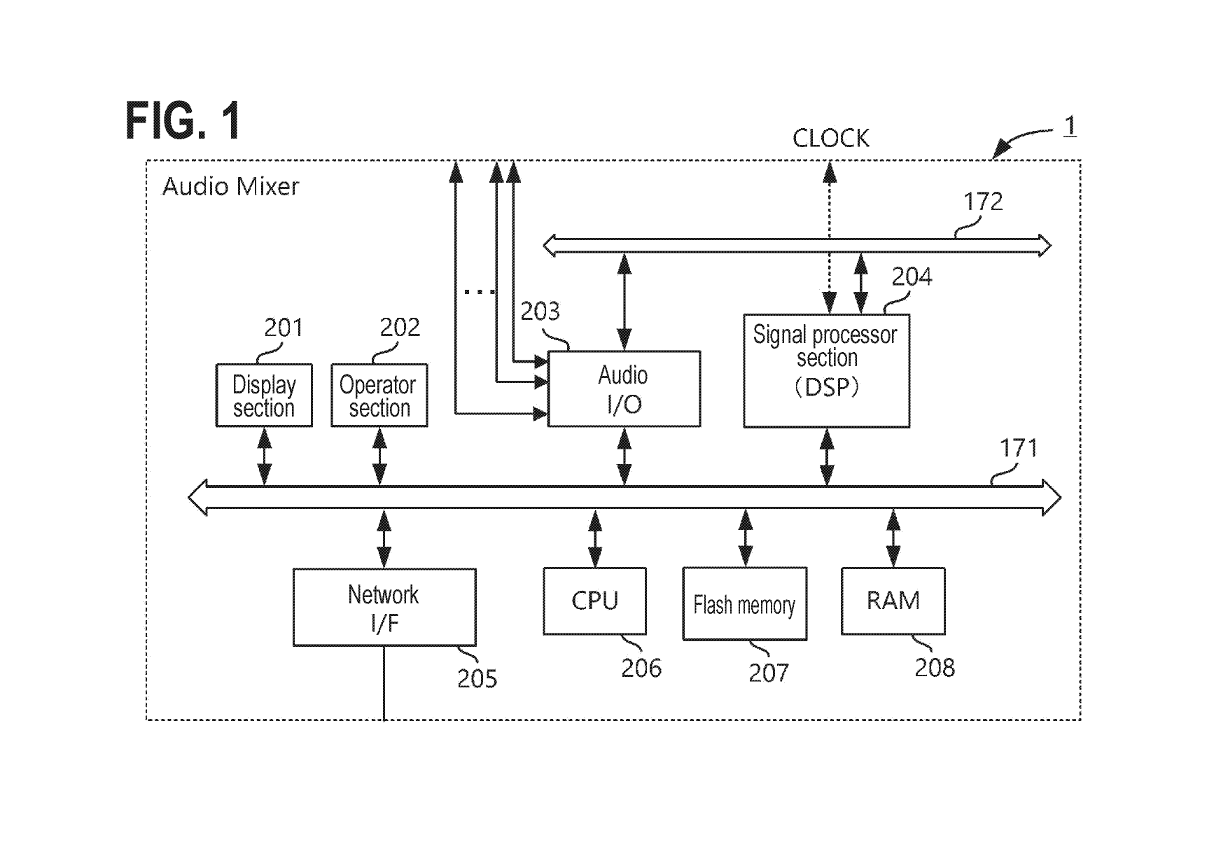

FIG. 1 is a block diagram illustrating the configuration of an audio mixer 1. The audio mixer 1 represents an example of a sound processing apparatus according to the present disclosure. The audio mixer 1 includes a display section 201, an operator section 202, an audio input/output (or I/O) 203, a signal processor section 204, a network interface (or I/F) 205, a CPU 206, a flash memory 207, and a RAM 208.

These elements are coupled through a bus 171. Further, the audio I/O 203 and the signal processor section 204 are coupled to a waveform bus 172 for conveying digitalized sound signals.

The CPU 206 serves as a controller for managing the operation of the audio mixer 1. The CPU 206 loads a prescribed program stored in the flash memory 207, which serves as a storage medium, in the RAM 208 for execution to implement a variety of operations. It should be recognized that the program may be stored in a server. The CPU 206 may download the program from the server over a network for execution.

The signal processor section 204 is implemented by one or more DSPs responsible for a variety of sound processing including mixing processing. The signal processor section 204 performs signal processing, including effect processing, level adjustment processing, and/or mixing processing, on sound signals received via the network I/F 205 and/or the audio I/O 203. The signal processor section 204 outputs processed and digitalized sound signals via the audio I/O 203 and/or the network I/F 205.

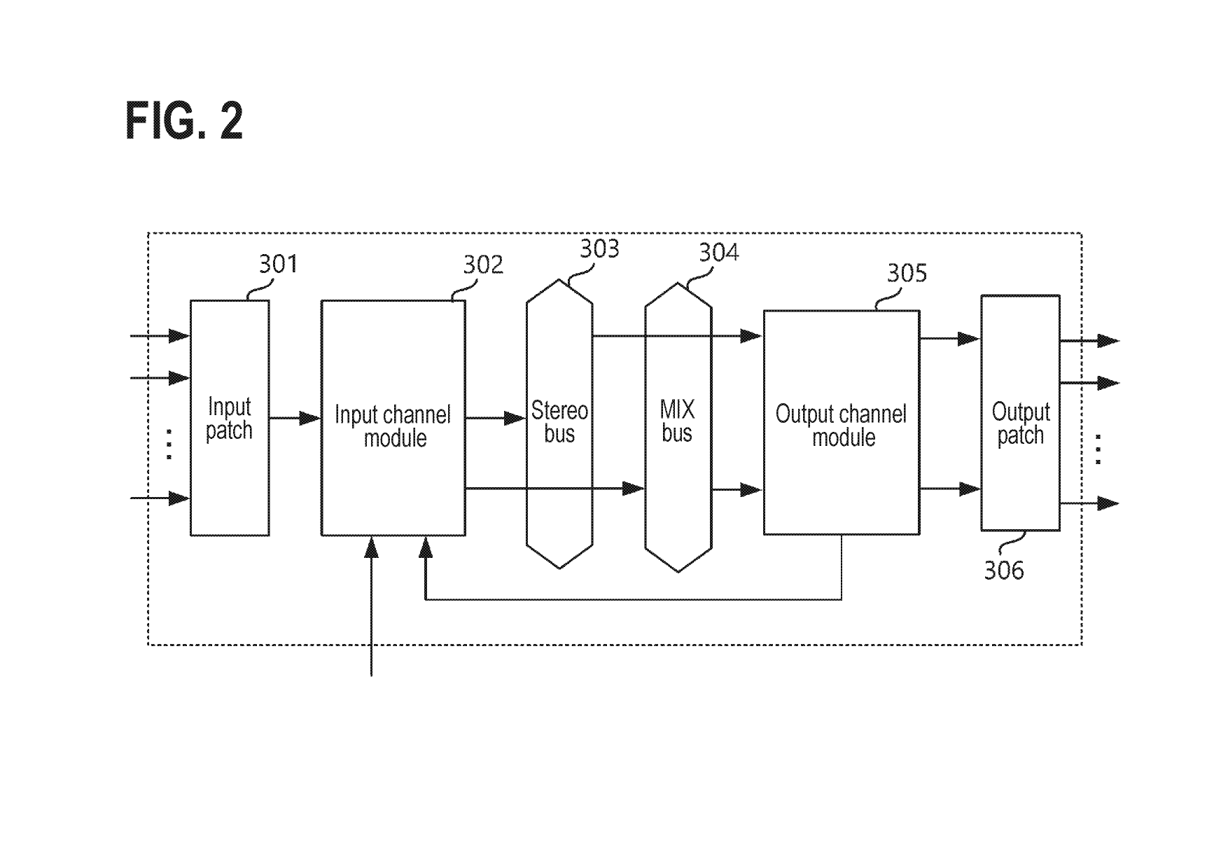

FIG. 2 is a block diagram illustrating the functional elements in signal processing implemented by the signal processor section 204, the audio I/O 203 (and/or the network I/F 205), and the CPU 206. Referring to FIG. 2, functionally, the signal processing makes use of an input patch 301, an input channel module 302, a stereo bus 303, a MIX bus 304, an output channel module 305, and an output patch 306.

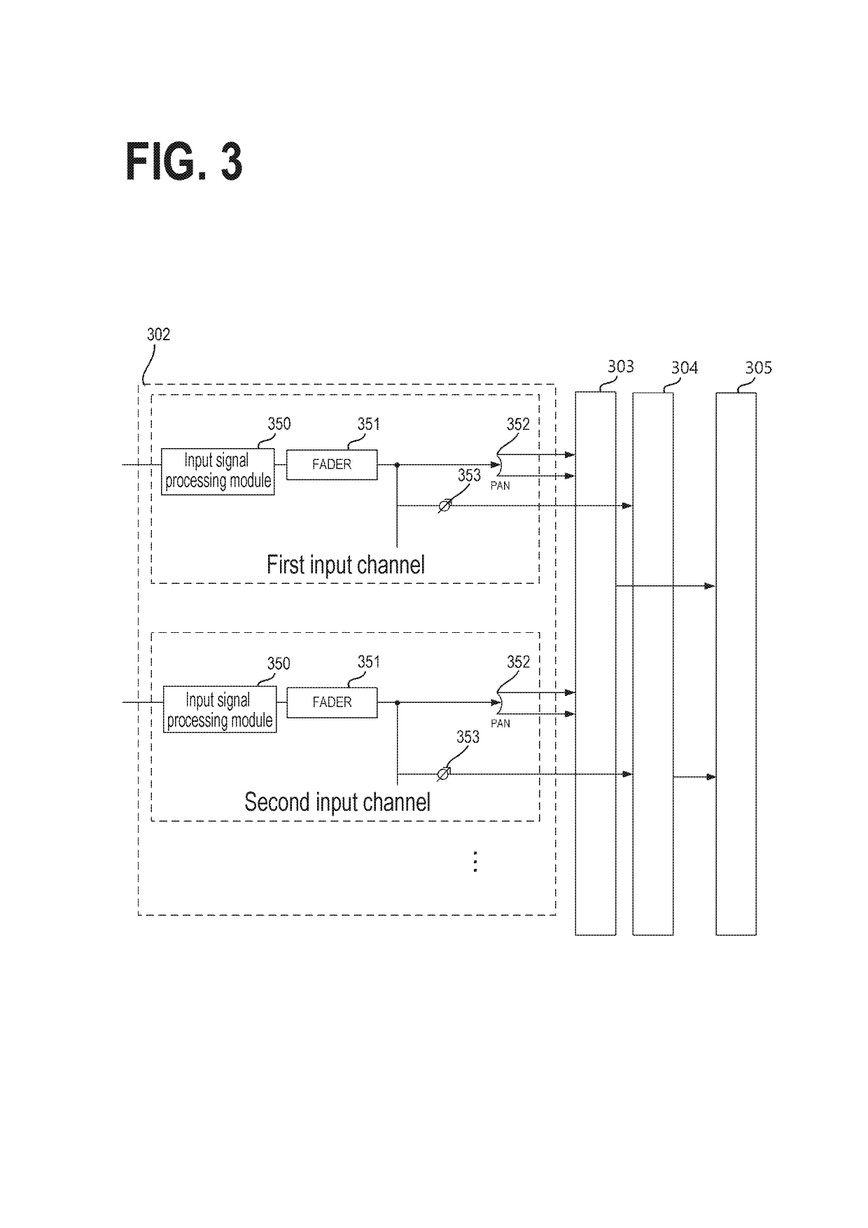

The input patch 301 can receive sound signals from a microphone, a musical instrument, a musical instrument amplifier, and/or any other suitable element. The input patch 301 feeds the received sound signals to channels in the input channel module 302. FIG. 3 is a block diagram illustrating how the input channel module is functionally configured. Each of the channels in the input channel module 302 can receive a sound signal from the input patch 301 so that signal processing may be applied to the sound signal.

FIG. 3 is a block diagram illustrating how the input channel module 302, the stereo bus 303, and the MIX bus 304 are functionally configured. In the illustrated example, each of a first input channel and a second input channel includes an input signal processing module 350, a FADER 351, a PAN 352, and a send level adjustment circuit 353. The other input channels (not shown) also include the same components.

The input signal processing module 350 applies effect processing involving an equalizer, a compressor, and/or any other suitable feature, level adjustment processing, and/or any other suitable processing. The FADER 351 adjusts the gain of a corresponding one of the input channels.

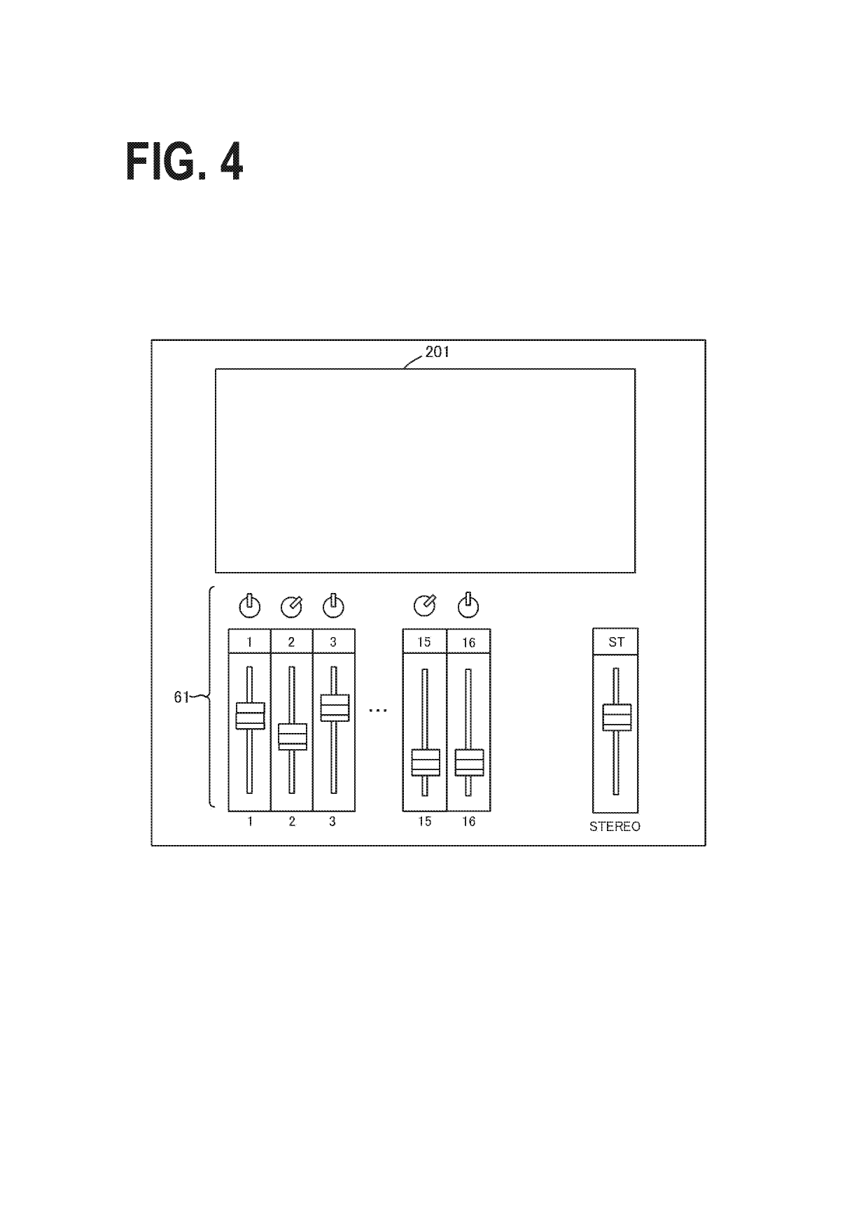

FIG. 4 is a schematic view of a control panel of the audio mixer 1. The control panel includes channel strips 61 associated with the respective input channels. Each of the channel strips 61 includes a slider and a knob, which are arranged in a longitudinally aligned manner, for a respective one of the channels. The slider can be associated with the FADER 351 of FIG. 3. A user of the audio mixer 1 changes the position of the slider to adjust the gain of a corresponding one of the input channels.

By way of example, the knob may be associated with the PAN 352 of FIG. 3. A user of the audio mixer 1 can turn the knob in a clockwise direction or counterclockwise direction to adjust the level balance between the left and the right of the stereo. The sound signal with stereo distribution made with the PAN 352 is sent to the stereo bus 303. Additionally or alternatively, by way of example, the knob may be associated with the send level adjustment circuit 353 of FIG. 3. A user of the audio mixer 1 can turn the knob in a clockwise direction or counterclockwise direction to adjust the amount sent to the MIX bus 304. Additionally or alternatively, the slider may serve as a controller used to adjust the amount sent to the MIX bus 304. In this scenario, the slider is associated with the send level adjustment circuit 353 of FIG. 3.

The stereo bus 303 may be associated with a main speaker at a hall or meeting room. The stereo bus 303 is where the sound signals sent from the input channels are mixed. The stereo bus 303 outputs the mixed sound signal to the output channel module 305.

The MIX bus 304 is used to send a mixed sound signal made from sound signals on one or more of the input channels to a selected acoustic device such as a monitor speaker or a monitor headphone. The MIX bus 304 outputs the mixed sound signal to the output channel module 305.

The output channel module 305 can apply effect processing involving an equalizer, a compressor, and/or any other suitable feature, level adjustment processing, and/or any other suitable processing on those sound signals output from the stereo bus 303 and MIX bus 304. The output channel module 305 outputs a processed, mixed sound signal to the output patch 306.

The output patch 306 assigns channels in the output channel module to one or more of a plurality of ports in an analog output port module or a digital output port module. In this way, processed sound signals are fed to the audio I/O 203 and/or the network I/F 205.

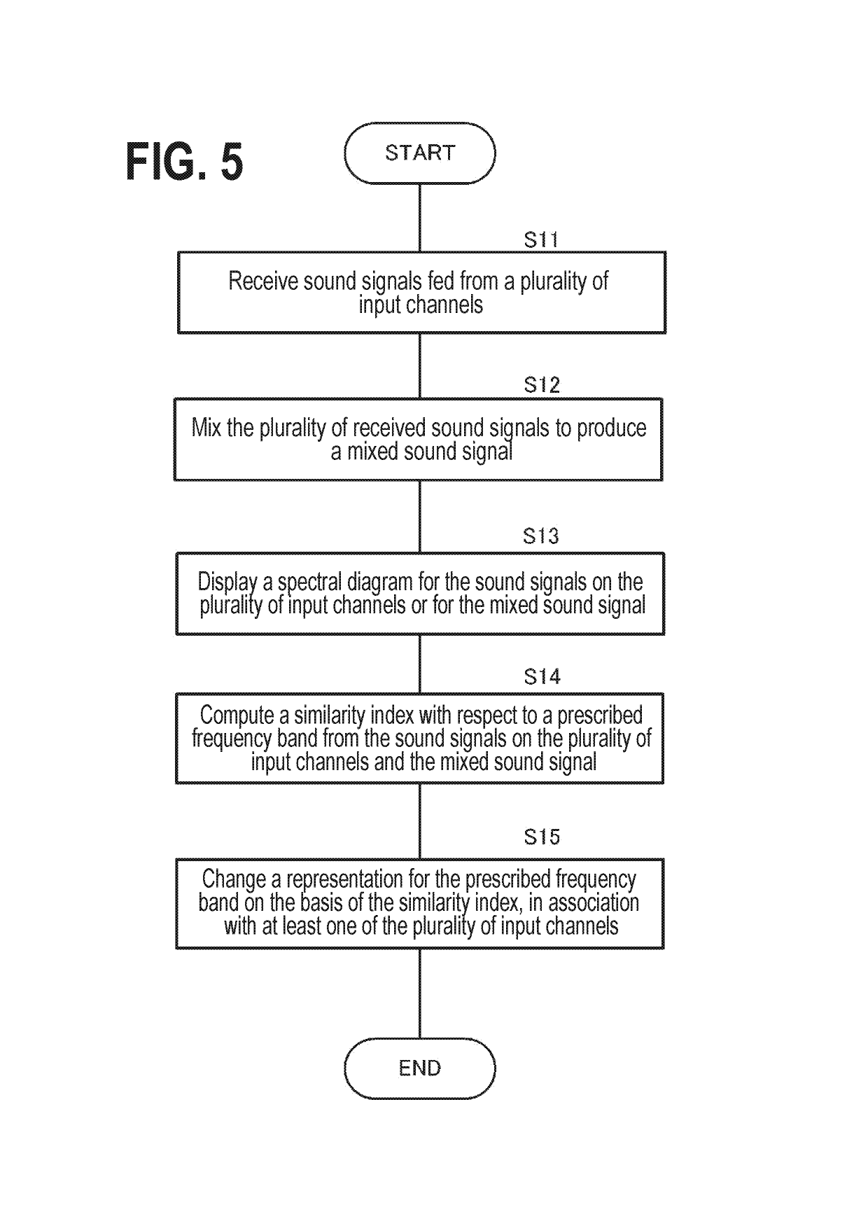

FIG. 5 is a flowchart of the operation of a sound processing method implemented by the audio mixer 1. The audio mixer 1 receives sound signals fed from a plurality of input channels (at step S11) for mixing to produce a mixed sound signal (at step S12). By way of example, in the context of FIG. 3, the stereo bus 303 receives and mixes sound signals fed from the channels in the input channel module 302 to produce a mixed sound signal. Additionally or alternatively, the MIX bus 304 receives and mixes sound signals fed from the channels in the input channel module 302 to produce a mixed sound signal.

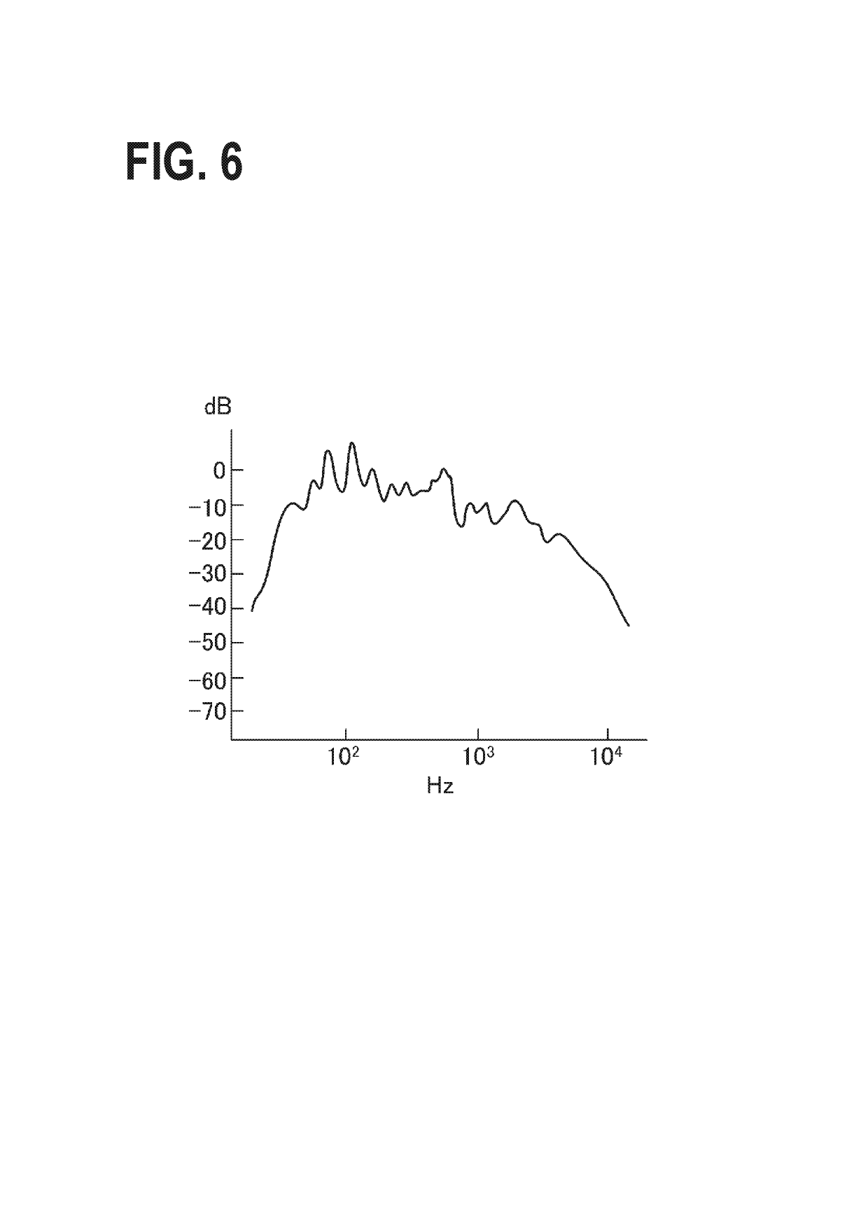

The audio mixer 1 displays a spectral diagram for the sound signals on the plurality of input channels or for the mixed sound signal (at step S13). FIG. 6 shows an example spectral diagram. The audio mixer 1 can have a spectral diagram such as the one in FIG. 6 displayed on the display section 201.

The horizontal axis and the vertical axis of the spectral diagram of FIG. 6 indicate a frequency and a level, respectively. In other words, the spectral diagram of FIG. 6 is displayed as a frequency versus energy chart. By way of example, FIG. 6 shows a spectral diagram of the mixed sound signal. A user of the audio mixer 1 can make adjustments to the parameters of equalizers in each input signal processing module 350, so that, for instance, the spectral diagram for the mixed sound signal better conforms to a desired or target frequency characteristic. In this process, the user may have a hard time finding out which one or ones of the input channels should be selected to make adjustments to the parameters of the corresponding equalizer(s) to modify the spectral characteristics of the mixed sound signal over a particular frequency range. For example, when it is wished to raise the level of a higher frequency range (at, for example, 1 to 5 kHz) in the mixed sound signal, not much change can be made to the spectrum of the mixed sound signal to this end by choosing one or more input channels with sound signal(s) having little influence in the higher frequency range, from among the plurality of input channels, for parameter adjustment. To address this issue, the audio mixer 1 of the instant embodiment is designed to present an indicator to show which one or ones of the input channels should be selected to make adjustments to the parameters of the corresponding equalizer(s) to modify the spectral characteristics of the mixed sound signal over a particular frequency range.

The audio mixer 1 computes a similarity index with respect to a given frequency band from the sound signals on the plurality of input channels and the mixed sound signal (at step S14). For example, the term “similarity index” used herein entails the concept of dominance or contribution (or influence) of a given input channel in the composition of a mixed sound signal. In one example, the similarity index is determined based on a cosine similarity for the given frequency band. A cosine similarity is defined as an inner product of two vectors divided by the magnitudes of the two vectors and takes the value between -1 and 1. When the cosine similarity is equal to 1, the two vectors are totally identical. When the cosine similarity is equal to -1, the two vectors have the same magnitude, but are in the opposite directions. The audio mixer 1 treats the spectrum of a sound signal as a multidimensional vector. For example, the audio mixer 1 regards prescribed, different frequency bands of the spectrum as the directions of the vector. The audio mixer 1 considers the levels of the frequency bands (or the averaged levels over all frequency bins for the respective frequency bands) as the magnitude of the vector. Additionally or alternatively, such a vector-to-vector similarity may be determined based on a Euclidean distance.

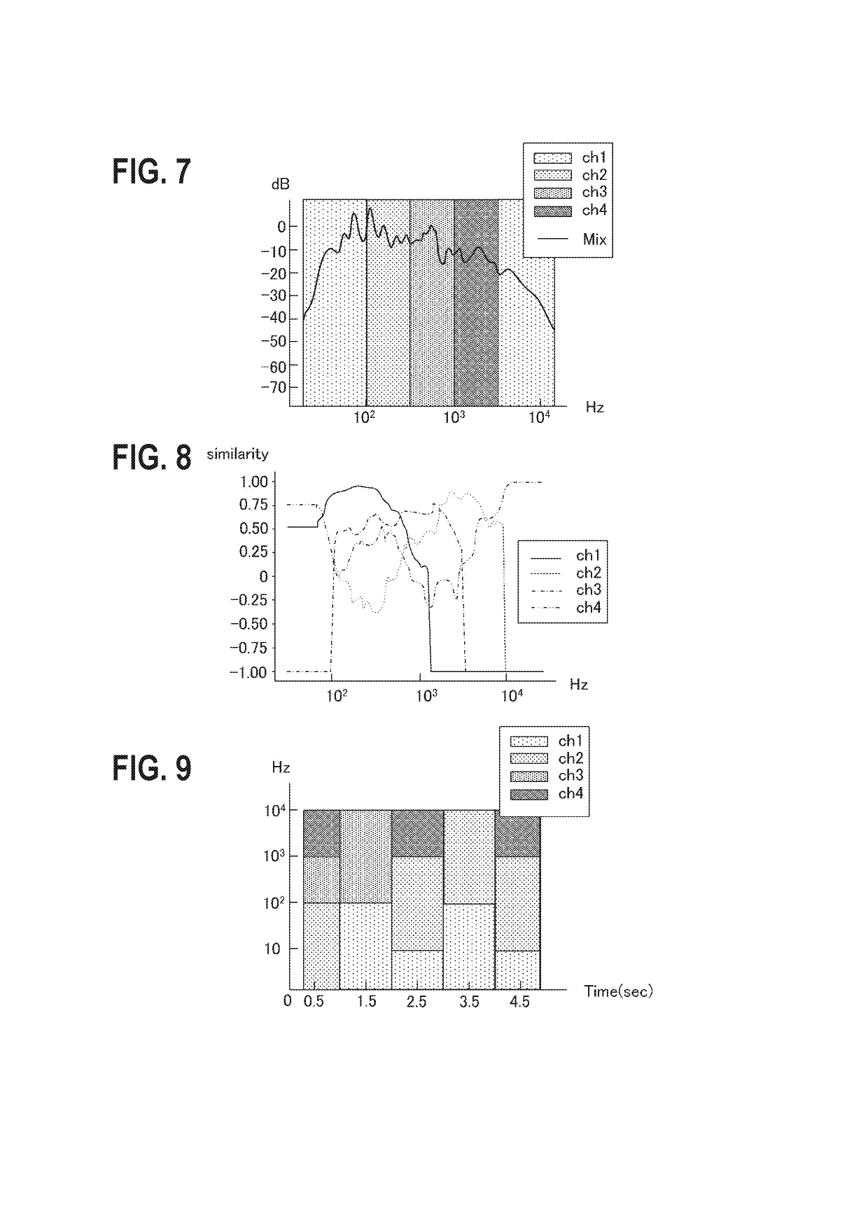

Then, the audio mixer 1 modifies a display representation for the given frequency band in the spectral diagram on the basis of the similarity index, in association with at least one of the plurality of input channels (at step S15). FIG. 7 shows the example spectral diagram after undergoing display representation modification. The horizontal axis and the vertical axis of the spectral diagram of FIG. 7 likewise indicate a frequency and a level, respectively. In other words, the spectral diagram of FIG. 7 is displayed as a frequency versus energy chart.

In the example of FIG. 7, for each given frequency band, the audio mixer 1 applies a colored overlay having color associated with one of the pluralities of the input channels with the highest similarity index to the mixed sound signal. In the illustrated example, the channel with the highest similarity index to the mixed sound signal for a frequency band covering frequencies of 100 Hz or less is a first input channel. The channel with the highest similarity index to the mixed sound signal for a frequency band covering frequencies of 100 to 500 Hz is a second input channel. The channel with the highest similarity index to the mixed sound signal for a frequency band covering frequencies of 500 to 1000 Hz is a third input channel. The channel with the highest similarity index to the mixed sound signal for a frequency band covering frequencies of 1000 to 5000 Hz is a fourth input channel. The channel with the highest similarity index to the mixed sound signal for a frequency band covering frequencies of 5000 Hz or more is the first input channel. Hence, the audio mixer 1 applies a colored overlay having color associated with the first input channel, for the frequency band covering frequencies of 100 Hz or less and the frequency band covering frequencies of 5000 Hz or more. The audio mixer 1 applies a colored overlay having color associated with the second input channel, for the frequency band covering frequencies of 100 to 500 Hz. The audio mixer 1 applies a colored overlay having color associated with the third input channel, for the frequency band covering frequencies of 500 to 1000 Hz. The audio mixer 1 applies a colored overlay having color associated with the fourth input channel, for the frequency band covering frequencies of 1000 to 5000 Hz.

In this way, a user of the audio mixer 1 can easily find out which one or ones of the input channels should be selected to make adjustments to the parameters of the corresponding equalizer(s) to modify the spectral characteristics of the mixed sound signal over a particular frequency range. For example, when it is wished to raise the level of a higher frequency range (at, for example, 1 to 5 kHz) in the mixed sound signal, a user of the audio mixer 1 can refer to the chart shown in FIG. 7 and intuitively recognize that the channel with the highest similarity index to the mixed sound signal for the frequency band covering the higher frequency range (at, for example, 1 to 5 kHz) is the fourth input channel. Thus, the user of the audio mixer 1 can intuitively understand that the input channel with a sound signal having an influence in the higher frequency range among the plurality of input channels is the fourth input channel. Accordingly, a user of the audio mixer 1 can enjoy a novel customer experience of being able to intuitively understand which one or ones of the input channels should be selected to perform parameter adjustments.

It should be appreciated that, while FIGS. 6 and 7 depict example spectral diagrams of a mixed sound signal, the audio mixer 1 may alternatively present individual spectral diagrams for the sound signals on the plurality of input channels or present both a spectral diagram for a mixed sound signal and individual spectral diagrams for the sound signals on the plurality of input channels.

The frequency versus energy chart is only one of the non-limiting representation examples of the spectral diagram. FIG. 8 shows another representation example of the spectral diagram. The horizontal axis and the vertical axis of the spectral diagram of FIG. 8 indicate a frequency and a similarity index, respectively. That is, the spectral diagram of FIG. 8 is displayed as a frequency versus similarity index chart.

In the illustrated example, a user of the audio mixer 1 can get a better understanding of the similarity index for each input channel computed for different frequency bands. Thus, a user of the audio mixer 1 can enjoy a novel customer experience of being able to get a better understanding of which one or ones of the input channels should be selected to perform parameter adjustments for different frequency bands.

FIG. 9 shows yet another representation example of the spectral diagram. The horizontal axis and the vertical axis of the spectral diagram of FIG. 9 indicate a time (in seconds) and a frequency, respectively. That is, the spectral diagram of FIG. 9 is displayed as a time versus frequency chart.

In the illustrated example, a user of the audio mixer 1 can see the timeline to temporally determine a channel with the highest similarity index to the mixed sound signal for a given frequency band. Thus, a user of the audio mixer 1 can enjoy a novel customer experience of being able to understand which one or ones of the input channels should be selected to perform parameter adjustments for different frequency bands while also paying attention to the passage of time.

It should be appreciated that the similarity index in the above scenario may be sampled as an instantaneous value (or a value after each sampling cycle) or a value determined per interval of a prescribed period of time (or, for example, one second). For example, the spectral diagram depicted in FIG. 9 can be displayed on the basis of a similarity index calculated per interval of one second. Alternatively, instantaneous values obtained within a prescribed period of time may be averaged over the prescribed period of time to be used as the similarity index.

Displaying the spectral diagram is optional for a sound processing method according to the present disclosure. A sound processing method according to the present disclosure may select the most dominant channel in a given frequency band in relation to a target frequency characteristic, on the basis of the similarity index.

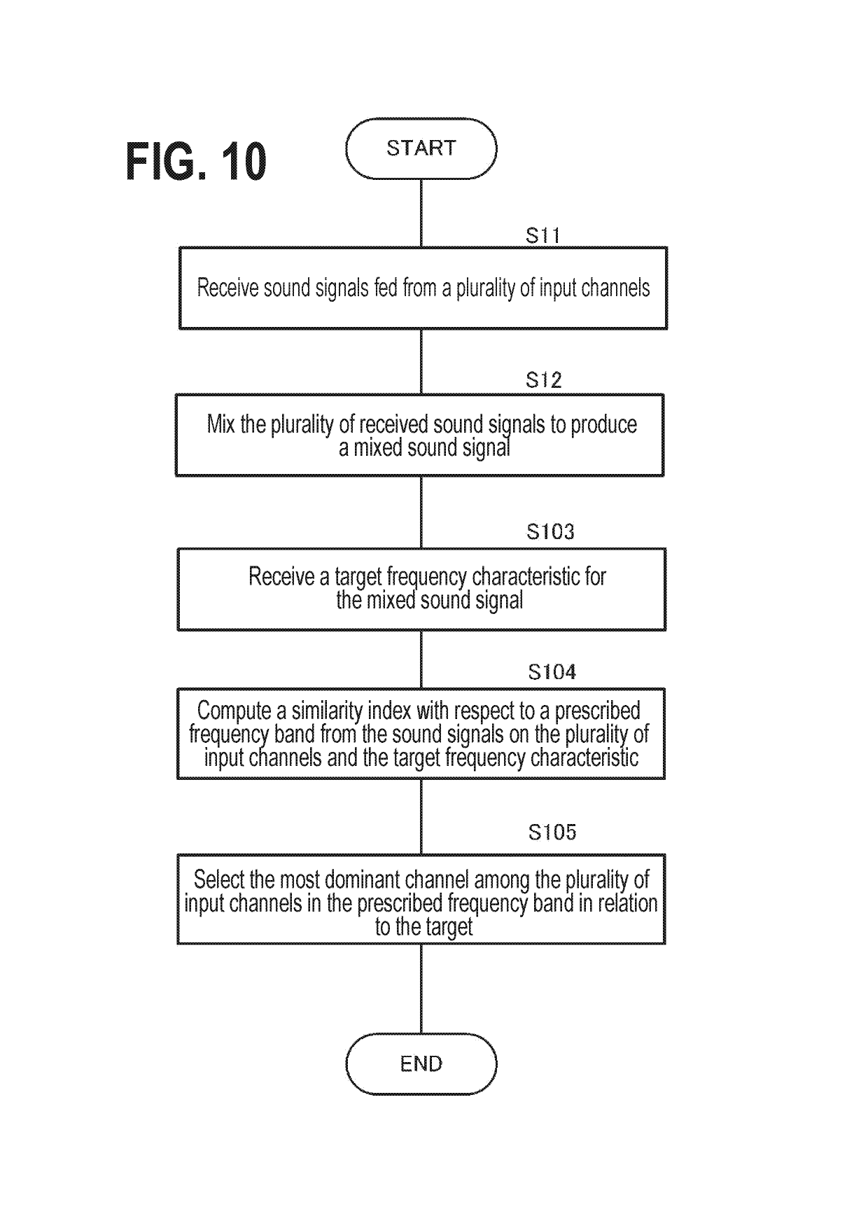

FIG. 10 is a flowchart of the process of selecting the most dominant channel. Those steps also found in FIG. 5 are indicated with the same reference symbols from FIG. 5 and will not be described to avoid repeated discussion.

In place of step S13 of FIG. 5, the audio mixer 1 receives a target frequency characteristic for the mixed sound signal (at step S103).

For example, the target frequency characteristic can be calculated from a piece of audio content (or a pre-existing mixed sound signal) of a particular piece of music, upon retrieving the piece of audio content. The target frequency characteristic may be acquired as the particular piece of music is selected from a database storing sound signals of a plurality of pieces of music. In this scenario, a user of the audio mixer 1 enters the name of a piece of music by acting on the operator section 202. The target frequency characteristic is derived from a mixed sound signal of a piece of audio content based on the entered name of a piece of music. The audio mixer 1 may identify a piece of music on the basis of a mixed sound signal generated as an output from the output channel module 305, retrieve a piece of audio content of a piece of music similar to the identified piece of music (and belonging to the same genre, for example), and acquire a target frequency characteristic from a mixed sound signal of the piece of audio content. In this process, a trained model that has learned the relationship between sound signals and names of pieces of music through machine learning can be used to estimate, from a mixed sound signal received as an input, the name of a corresponding piece of music.

Target frequency characteristics may be acquired in advance and stored in the flash memory 207. Additionally or alternatively, target frequency characteristics may be stored in a server (not shown).

Further, target frequency characteristics may be derived in advance from mixed sound signals produced as a result of ideal parameter adjustments made by skilled users (or PA engineers) using audio mixers. Moreover, target frequency characteristics may be derived in advance from pieces of audio content that have been edited by skilled recording engineers. A user of the audio mixer 1 can act on the operator section 202 to enter the name of a PA engineer or the name of a recording engineer. Upon receiving the name of a PA engineer or the name of a recording engineer, the audio mixer 1 acquires an associated target frequency characteristic.

The target frequency characteristic may be derived in advance on the basis of a plurality of pieces of audio content upon retrieving the plurality of pieces of audio content. For instance, the target frequency characteristic may be in the form of an averaged frequency characteristic among a plurality of mixed sound signals from the plurality of respective pieces of audio content. The averaged frequency characteristic may be determined per piece of music, per genre, or per engineer.

Additionally or alternatively, the audio mixer 1 may retrieve in advance multiple pieces of audio content belonging to the same genre for each of a plurality of genres, and may train a prescribed model, through machine learning, with the relationships between different genres and associated target frequency characteristics and obtain a trained model. Moreover, the audio mixer 1 may retrieve multiple pieces of audio content, including pieces of audio content from pieces of music belonging to a common genre but with different musical arrangements and/or pieces of audio content belonging to a common genre but with different musical players or performers, and may build a trained model that can estimate, from a desired genre and a desired musical arrangement, a corresponding target frequency characteristic and/or a trained model that can estimate, from a desired genre and a desired musical player or performer, a corresponding target frequency characteristic. A user of the audio mixer 1 can act on the operator section 202 to enter the name of a genre and/or the name of a piece of music. Upon receiving the name of a genre and/or the name of a piece of music, the audio mixer 1 acquires a corresponding target frequency characteristic.

Referring back to FIG. 10, the audio mixer 1 (at step S104) computes a similarity index with respect to a given frequency band from the sound signals on the plurality of input channels and the target frequency characteristic acquired at step S103.

Then, the audio mixer 1 (at step S105) selects the most dominant channel among the plurality of input channels in the given frequency band in relation to the target frequency characteristic, on the basis of the similarity index computed at step S104.

The similarity index at step S104 may be determined based on a cosine similarity or a Euclidean distance as previously described, or any other suitable method. By way of example, the similarity index may be determined by a trained model configured to receive as input the plurality of channels and the target frequency characteristic to give as output the most dominant channel based on the similarity index.

Datasets each including a target frequency characteristic and a label indicating which one or ones of the input channels should be worked on for each given frequency band relating to the target frequency characteristic for adjustment to better conform to the target frequency characteristic are provided to the audio mixer 1. The audio mixer 1 uses the datasets to train a prescribed model. That is, the audio mixer 1 trains the prescribed model to output a label indicating the most influential (or the most dominant) channel for a target frequency characteristic when receiving as input a plurality of channels and the target frequency characteristic. The audio mixer 1 feeds sound signals on a plurality of input channels and a target frequency characteristic to the trained model as input in order to obtain label information indicating a corresponding channel. In this way, the audio mixer 1 can select the most dominant channel among the plurality of input channels in the given frequency band in relation to the target frequency characteristic, on the basis of the similarity index.

Additionally or alternatively, the audio mixer 1 may compare the target frequency characteristic and the frequency characteristic of a mixed sound signal to decide the frequency band to work on for adjustment and subsequently apply a cosine similarity or a Euclidean distance as previously described, or any other suitable method to the decided frequency band to select an input channel with the highest similarity index. In this scenario, too, the audio mixer 1 can select the most dominant channel among the plurality of input channels in the given frequency band in relation to the target frequency characteristic.

The audio mixer 1 may present a visual indication of the selected channel, or may set, for example, the central frequency for parametric equalizer processing to be applied to a sound signal on the selected channel, within an associated frequency band.

In this scenario, too, a user of the audio mixer 1 can enjoy a novel customer experience of being able to intuitively understand which one or ones of the input channels should be selected to perform parameter adjustments.

The description of the embodiments should be considered illustrative and not restrictive in all respects, and the scope of the present disclosure is to be defined not by the foregoing embodiments but by the appended claims. Moreover, the scope of the present disclosure shall encompass all variations that would come within the meaning and breadth of equivalency of the claims.

By way of example, the similarity index may also be determined based on the intensity of energy for a given frequency band. In other words, the audio mixer 1 may determine the levels of the different frequency bands (or the averaged levels over all frequency bins for the respective frequency bands) to use these levels in the similarity index calculation.

Further, the similarity index may be determined by a trained model configured to receive as input the plurality of channels and the mixed sound signal to give as output the most dominant channel based on the similarity index. Datasets each including a mixed sound signal and a label indicating which one of the input channels is the most dominant for each given frequency band of the mixed sound signal are provided to the audio mixer 1. The audio mixer 1 uses the datasets to train a prescribed model. That is, the audio mixer 1 trains the prescribed model to output a label indicating the most dominant channel based on the similarity index when receiving as input a plurality of channels and the mixed sound signal. The audio mixer 1 feeds a plurality of channels and a mixed sound signal as input in order to obtain label information indicating a corresponding channel. In this way, the audio mixer 1 can modify a display representation for the given frequency band on the basis of the similarity index or can select the most dominant channel among the plurality of input channels in the given frequency band in relation to the target frequency characteristic.

It is worthwhile to note that a storage medium storing a control program represented by software for realizing the present disclosure can be loaded into the parameter selection apparatus or an associated memory to produce similar advantages according to the present disclosure. In that case, the program code read from the storage medium implements a set of novel functions of the present disclosure, and the non-transitory, computer-readable storage medium storing the program code forms one aspect of the present disclosure. In some examples, the program code may also be conveyed on a propagation medium. In that case, the program code itself forms another aspect of the present disclosure. It should be noted that examples of the storage medium that can be adopted in these situations include a ROM, a diskette, a hard disk, an optical disk, a magneto-optical disk, a CD-ROM, a CD-R, a magnetic tape, and a non-volatile memory card. Examples of the non-transitory, computer-readable storage medium can even encompass those entities that retain the program for some duration of time, such as volatile memories (e.g., a DRAM (or Dynamic Random Access Memory)) within a computer system that serves as a server and/or client used to transmit the program over a network such as the Internet and/or a communication line such as a telephone line.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

WHAT IS CLAIMED IS:

1. A sound processing method comprising:
receiving and mixing sound signals fed from a plurality of input channels to produce a mixed sound signal;
displaying a spectral diagram for the sound signals on the plurality of input channels or for the mixed sound signal;
computing a similarity index with respect to a given frequency band from the sound signals on the plurality of input channels and the mixed sound signal; and
modifying a display representation for the given frequency band in the spectral diagram on the basis of the similarity index, in association with at least one of the plurality of input channels.

2. A sound processing method comprising:
receiving and mixing sound signals fed from a plurality of input channels to produce a mixed sound signal;
receiving a target frequency characteristic for the mixed sound signal;
computing a similarity index with respect to a given frequency band from one of the sound signals, which is fed from one of the plurality of input channels, and the target frequency characteristic; and
selecting a most dominant channel among the plurality of input channels in the given frequency band in relation to the target frequency characteristic, on the basis of the similarity index.

3. The sound processing method according to claim 1, wherein the similarity index is determined based on a cosine similarity for the given frequency band.

4. The sound processing method accordifng to claim 2, wherein the similarity index is determined based on a cosine similarity for the given frequency band.

5. The sound processing method according to claim 1, wherein the similarity index is determined based on an intensity of energy for the given frequency band.

6. The sound processing method according to claim 2, wherein the similarity index is determined based on an intensity of energy for the given frequency band.

7. The sound processing method according to claim 1, wherein the similarity index is determined by a trained model configured to receive as input the plurality of channels and the mixed sound signal to give as output a most dominant channel based on the similarity index.

8. The sound processing method according to claim 2, wherein the similarity index is determined by a trained model configured to receive as input the plurality of channels and the mixed sound signal to give as output a most dominant channel based on the similarity index.

9. A sound processing apparatus comprising:
a processor; and
a memory storing instructions that, when executed by the processor, cause the processor to carry out:
receiving and mixing sound signals fed from a plurality of input channels to produce a mixed sound signal;
displaying a spectral diagram for the sound signals on the plurality of input channels or for the mixed sound signal;
computing a similarity index with respect to a given frequency band from the sound signals on the plurality of input channels and the mixed sound signal; and
modifying a display representation for the given frequency band in the spectral diagram on the basis of the similarity index, in association with at least one of the plurality of input channels.

10. A sound processing apparatus comprising:
a processor; and
a memory storing instructions that, when executed by the processor, cause the processor to carry out:
receiving and mixing sound signals fed from a plurality of input channels to produce a mixed sound signal;
receiving a target frequency characteristic for the mixed sound signal;
computing a similarity index with respect to a given frequency band from one of the sound signals, which is fed from one of the plurality of input channels, and the target frequency characteristic; and
selecting a most dominant channel among the plurality of input channels in the given frequency band in relation to the target frequency characteristic, on the basis of the similarity index.

11. The sound processing apparatus according to claim 12, wherein the similarity index is determined based on a cosine similarity for the given frequency band.

12. The sound processing apparatus according to claim 13, wherein the similarity index is determined based on a cosine similarity for the given frequency band.

13. The sound processing apparatus according to claim 12, wherein the similarity index is determined based on an intensity of energy for the given frequency band.

14. The sound processing apparatus according to claim 13, wherein the similarity index is determined based on an intensity of energy for the given frequency band.

15. The sound processing apparatus according to claim 12, wherein the similarity index is determined by a trained model configured to receive as input the plurality of channels and the mixed sound signal to give as output a most dominant channel based on the similarity index.

16. The sound processing apparatus according to claim 13, wherein the similarity index is determined by a trained model configured to receive as input the plurality of channels and the mixed sound signal to give as output a most dominant channel based on the similarity index.

17. The sound processing apparatus according to claim 12, wherein the spectral diagram is displayed as a frequency versus similarity index chart.

18. The sound processing apparatus according to claim 12, wherein the spectral diagram is displayed as a time versus frequency chart.

19. A non-transitory computer-readable storage medium storing a sound processing program executable by at least one processor of a sound processing apparatus, that when executed by the at least one processor, causes the at least one processor to execute a method comprising:
receiving and mixing sound signals fed from a plurality of input channels to produce a mixed sound signal;
displaying a spectral diagram for the sound signals on the plurality of input channels or for the mixed sound signal;
computing a similarity index with respect to a given frequency band from the sound signals on the plurality of input channels and the mixed sound signal; and
modifying a display representation for the given frequency band in the spectral diagram on the basis of the similarity index, in association with at least one of the plurality of input channels.

20. A non-transitory computer-readable storage medium storing a sound processing program executable by at least one processor of a sound processing apparatus, that when executed by the at least one processor, causes the at least one processor to execute a method comprising:
receiving and mixing sound signals fed from a plurality of input channels to produce a mixed sound signal;
receiving a target frequency characteristic for the mixed sound signal;
computing a similarity index with respect to a given frequency band from one of the sound signals, which is fed from one of the plurality of input channels, and the target frequency characteristic; and
selecting a most dominant channel among the plurality of input channels in the given frequency band in relation to the target frequency characteristic, on the basis of the similarity index.
